(19) United States
(12) Patent Application Publication
(10) Pub. No.: US 2010/0170916 A1
(43) Pub. Date: Jul. 8, 2010

(54) CONTROL SYSTEM FOR A BEVERAGE DISPENSING APPARATUS

(75) Inventor: Roelof Anton Segers, Bussum (NL)

Correspondence Address: Pearne & Gordon LLP, 1801 East 9th Street, Suite 1200, Cleveland, OH, 44114-3108, US

(73) Assignee: HEINEKEN SUPPLY CHAIN B.V., 1017 ZD AMSTERDAM (NL)

(21) Appl. No.: 12/602,352

(22) PCT Filed: Jun. 2, 2008
(86) PCT No.: PCT/NL2008/050336

§ 371 Date: Mar. 16, 2010

(30) Foreign Application Priority Data
May 31, 2007 (NL) 1033913

(51) Int. Cl. B67D 1/08

(52) U.S. Cl. 222/1; 222/148

(57) ABSTRACT

A control system for a beverage dispensing apparatus, wherein the beverage dispensing apparatus comprises at least one line system with at least one rising line and a tapping line and at least one holder for beverage, wherein the control system comprises a flow sensor, wherein the control system comprises operating means for switching between a first condition in which beverage can be dispensed from the holder via the tapping line and the rising line is separated from the tapping line and a second condition in which rinsing liquid and/or water can be introduced via the rinsing line into the tapping line and the holder is separated from the tapping line and the rinsing line.

The invention relates to a control system for a beverage dispensing apparatus.

Beverage dispensing apparatuses comprising a line system with at least one rinsing line and a tapping line and at least one holder for beverage are known. If tapping from this at least one holder is terminated, the connecting device connecting the container to the line system is closed or uncoupled, whereupon in a cleaning stage, via the rinsing line, rinsing liquid is supplied through the rinsing line and the tapping line for cleaning the line system. One or more tapping points can be provided, connected to the line system. During rinsing, the or each draw-off tap should be open in order to carry off the rinsing liquid.

It is of great importance that renewed utilization of the tapping device after a cleaning phase, before a tapping phase in which beverage can be dispensed from at least one container, all rinsing liquid is removed from the line system, at least from each tapping line. To that end, in the known tapping device, the or each draw-off tap is to be manually opened and it is to be checked whether it/they remain(s) open during the entire cleaning phase, which is time consuming and can furthermore easily lead to mistakes.

It is known to use, in such an apparatus, rinsing liquid with a particular color that clearly deviates from water and from the beverage to be dispensed. This enables visual inspection as to whether all cleaning liquid has flowed from a particular line. To that end an optical sensor may be built in. The fact is that as soon as the discoloration has disappeared, the cleaning liquid has been carried off. This however does not yet ensure that the cleaning liquid has been fed through all lines or that all draw-off taps have been open all the time.

In a further known apparatus, use is made of a cleaning liquid with a coefficient of conductivity that deviates from that of clean water and from that of the beverage to be dispensed. A sensor is built-in with which the electrical conductivity of liquid flowing along the sensor is measured. As long as this measures the conductivity of the cleaning liquid, cleaning liquid is still to be carried off. Such an apparatus has as a drawback that a special cleaning liquid is to be used, while furthermore, it is clear only whether in a part of the line system located upstream of the sensor the cleaning liquid has disappeared, and not from the or each part between the sensor and the draw-off tap.

The object of the invention is to offer a system with which at least one of the drawbacks of at least one of the known apparatuses is obviated.

In a first aspect, a control system for a beverage dispensing apparatus is characterized in that a flow sensor is provided to be included in the line system, wherein the control system comprises operating means for switching between a first condition in which the beverage can be dispensed from the holder via the tapping line and the rinsing line is separated from the tapping line, and a second condition in which rinsing liquid and/or water can be introduced via the rinsing line into the tapping line and the holder is separated from the tapping line and the rinsing line.

With the aid of the flow sensor, during a rinsing phase, it can each time be checked whether flow of the rinsing liquid occurs in the line system. If a tapping device is used with only one draw-off tap, the flow sensor will establish whether flow occurs in the line system. If this is not the case for a period of time, a signal can be given to the control system, for instance to a regulator unit, so that the cleaning phase can be interrupted, an alarm can be produced or in another manner, an indication can be given to the user or manager that the rinsing phase has not proceeded in a desirable manner, or that it has stopped at a desired moment in time, the rinsing phase can be gone through again and/or the beverage dispensing can be terminated.

In a second aspect, a control system comprises a comparator for comparing, in the second condition, the flow in the line system with a set minimum flow threshold value (MFT), and means for generating an alarm signal when this flow falls below said minimum flow threshold value (MFT).

In a further aspect, the flow sensor is included in the rinsing line, preferably upstream of a first holder and in particular in a part of the line system where there are no beverage dispensing lines. More particularly, there is the possibility to predetermine the MFT on the basis of the total volume of the line system, so that when at least one tapping point closes, the MFT is already underspent and an alarm signal is produced.

In this description, alarm signal is understood to mean at least but not exclusively a signal that is generated on the basis of which the user or manager of the beverage dispensing apparatus can establish that the rinsing phase has not proceeded properly or, for instance, a signal that interrupts the rinsing phase.

Alternatively, for instance in or near each draw-off tap, a flow sensor can be provided, wherein for each flow sensor an MFT can be set or for a combination of two or more, or, for instance, all flow sensors an MFT can be set.

In a second aspect, the control system comprises an operating means for, for instance, a shutoff for supply of the rinsing agent, for a three or other multi-way valve between a first position, in which the rinsing line is brought into fluid communication with the tapping line and a second position in which the holder is brought into fluid communication with the tapping line and/or timer means are provided for timing the duration of the second condition and other means inside and outside the tapping device. The operating device preferably comprises a touch screen on which the alarm mentioned can be represented and, for instance, the progress of a rinsing cycle, the second condition, can be represented. The operating means, in particular the touch screen may also be designed for starting an automatic rinsing cycle, for representing status information about the beverage dispensing apparatus, such as, for instance, the amount of beverage in the or each container, the dispensed amount of beverage, the time that has elapsed since a previous rinsing cycle, the stock of rinsing agent and other information.

Preferably, such an operating means, or at least the interface thereof, such as the touch screen mentioned, is arranged adjacent a tapping point, so that the apparatus can be checked and operated remote from the holders. It is furthermore preferred that the control system be provided with communication means, in particular wireless and/or via an internal or external network such as, for instance but not limited to intranet, extranet or Internet, whereby management of the beverage dispensing apparatus and information exchange between different parties involved in the apparatus and the exploitation thereof, such as the manager of the beverage dispensing apparatus, the suppliers, the brewery and such parties, is simplified.

The invention further relates to a method for management of a beverage dispensing apparatus.

In a first aspect, such a method comprises a central operating system in which information is collected and stored about at least one of the connected holders, amounts of beverage present in the holders, best-before dates with respect to the beverage in the holders and cleaning data of the beverage dispensing apparatus, wherein, in the operating system, an algorithm is included for determining, on the basis of the information mentioned, a cleaning interval or cleaning moment and/or for running a cleaning program, which program, upon activation by a user:
seals off the or each holder from the or each tapping line of the beverage dispensing apparatus;
connects a rinsing line of the beverage dispensing apparatus to the or each tapping line;
during a first period, displaces beverage from the or each tapping line by introducing water and/or rinsing liquid via the rinsing line into one or each tapping line, while displacing the beverage present therein;
during a first period, feeds rinsing liquid through the rinsing line and tapping line or tapping lines;
during a second period, feeds water through said rinsing line and tapping line or tapping lines, for displacing rinsing liquid from at least the tapping line or tapping lines;
after a second period, connects at least one holder to the tapping line or tapping lines, while disconnecting the fluid communication between the said rinsing line or the or each tapping line.

Thus, at least virtually automatically, a rinsing cycle can be carried out.

The invention further relates to a regulator device for use in a control system or with a method according to the invention.

The invention further relates to a computer software product for a control system for a beverage dispensing apparatus.

The invention will be further elucidated on the basis of the drawing. In the drawing:

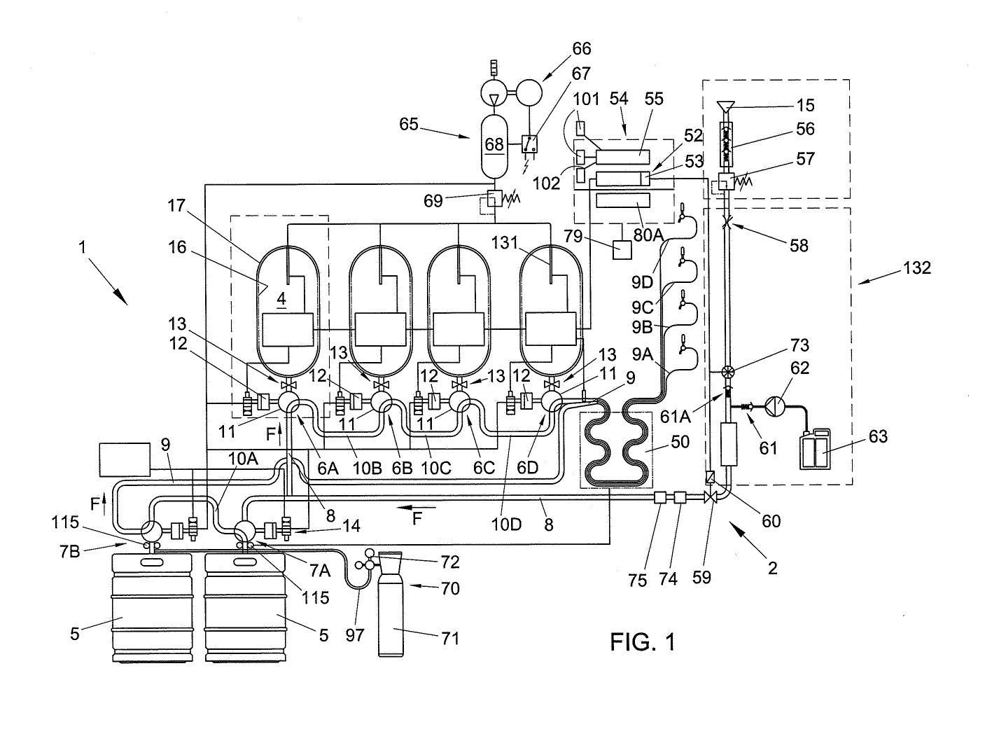

FIG. 1 schematically shows the lay out of a beverage dispensing apparatus;

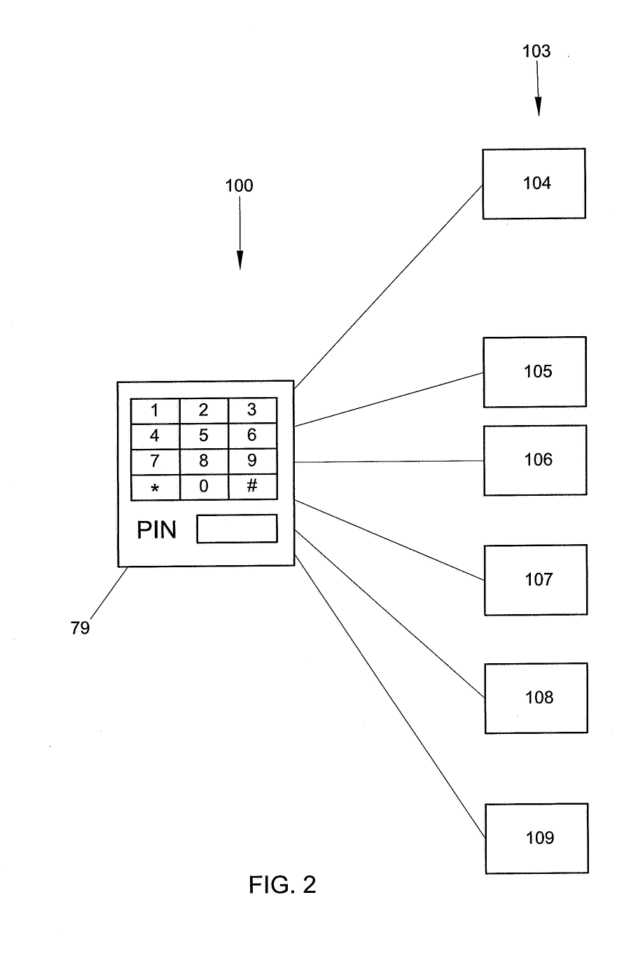

FIG. 2 schematically shows a control system for a beverage dispensing apparatus.

In this description, identical or corresponding parts have identical or corresponding reference numerals. The embodiments shown are shown merely by way of illustration and should not be construed to be limitative in any manner. In this description, apparatuses and associated parts will be described on the basis of an apparatus for dispensing beer. However, an apparatus or associated parts can also be used for dispensing other types of beverage, such as soft drink or wine.

In FIG. 1, schematically, an apparatus 1 according to the invention is shown, comprising a line system 2 and a series of draw-off taps 3. In the exemplary embodiment shown, four draw-off taps are shown, but in principle, any number of draw-off taps 3 is possible. Further, four other holders 4 are shown, in particular of the bag-in-container (BIC) type as known from, for instance, known cellar beer apparatuses, or a BIC as will be further described on the basis of FIG. 2, and two smaller holders in the form of kegs 5. The different parts are not represented to scale. Other combinations of types of holders are possible too.

Each holder 4 is couplable with the aid of a first type of connecting head 6 to the line system 2, while the holder 5 is also couplable via a second type of connection head 7 to the line system 2. In the embodiment shown, viewed in flow direction F of the line system 2, the kegs 5 are arranged parallel to the holders 4 and coupled to the line system 2. However, this can be done in any random order, parallel as well as serially or combinations thereof. The line system 2 comprises a rinsing line 8, a tapping line 9 which, in the example shown is partly divided in a manner to be further described into four sub-tapping lines 9A-D, and five intermediate lines 10A-E, which will be described in further detail.

Each connecting head 6 of the first type comprises a shutoff 13, a three-way valve 11 and operating means 12 for the three-way valve 11, which together therewith can be indicated as three-way valve device. In the exemplary embodiment shown, the operating means 12 are pneumatic means but can also be of different design, for instance of electrical or hydraulic design. With the aid of the operating means 12, the three-way valve is operable between a first and a second position, as will be discussed in further detail. The or each second type of connecting head 7 is for instance designed as shown in FIG. 3 or 4 and will be further described. This connecting head 7 can also be switched between a first and a second position with the aid of operating means 14, as will be further described. This connecting head 7 can for instance be designed as a known changeover keg head.

The shutoff 13 and the three-way valve 11 can be combined into a four-way valve so that filling, cleaning and dispensing beverage through the same multi-way valve is possible. Optionally, a multi-way valve with several inlets and outlets can be utilized, for instance for parallel connection of, for instance, a number of kegs and/or other containers for forming a bypass or the like.

The rinsing line 8 extends between an inlet combination 132 connected to a water connection 15, and the connecting head foremost viewed in flow direction F, in the embodiment shown connecting head 7A and, via a branch, in the first head 6A. A tapping line 9 extends from the connecting head 7A, rearmost viewed in the flow direction F, and rearmost connecting head 6D and connects these, via the sub-tapping lines or intermediate lines 9A-D, to the different draw-off taps 4A-D. The sub-tapping lines 9A-D and/or the tapping line(s) 9 preferably partly extend through a through-flow cooler 50 and can, furthermore, be of cooled design, for instance as a python. The intermediate line 10A connects the tapping head 7A, foremost in flow direction F, to the second 7B, while the second tapping head 7B is connected to the tapping line 9, while the intermediate lines 10B-10C connect the third tapping head 6A to the fourth tapping head 6B, the fourth tapping head 6B to the fifth tapping head 6C, and the fifth tapping head 6C to the sixth tapping head 6D, respectively. It will be clear that other numbers of kegs and/or tanks can be utilized too, in a line circuit with one or more flow paths. Only the tapping line, intermediate lines 10B-D and the rinsing line may suffice too, i.e. without the kegs, or, conversely, just kegs and no tanks, with no branch or, conversely, several branches for separate circuit parts. For the tanks and kegs or other containers also, separate draw-off taps may be provided, connected to different tapping lines.

As appears from FIG. 1, the operating means 12, 14 of the connecting heads 6, 7 are connected to a central regulator device 52, preferably an electronic regulator unit, such as a regulator unit with processor 53 and interface 54, such as a touch screen 55. In the rinsing line 8, between the water connection 15 and the first connecting head 6A, an inlet combination 132 with safety control 56 in the form of a three-way KIWA safety are provided, to prevent rinsing liquid or polluted water from flowing back into a (public) water mains (not shown), a reducing valve 57, an adjustable throttle 58, a water valve 59, preferably provided with drive means 60, such as electric operating means for opening, closing and regulating these, and a connection 61 for a pump 62, in particular a dosing pump such as a hose pump for dosing cleaning agent, such as a lye, from a storage tank 63. At least the drive means 60 and the dosing pump 62 are connected to the regulator device 52. Between the connection 61 and the pump 62, preferably, a non-return valve 64 is provided. A measuring device 74 may be provided with which a parameter of the rinsing liquid or at least a liquid in the rinsing line or elsewhere in the line circuit can be measured, in order to ascertain whether this liquid is “clean” water or rinsing liquid with, for instance, a soap, lye or other cleaning agent. To that end, the sensor 74 may be or comprise a conductivity sensor. Other sensors too can be utilized, such as for a pH measurement, color measurement or the like.

Supply means 65 for supply of pressure gas, such as compressed air are provided, comprising a compressor 66 with control 67, a buffer tank 68 and reducing valves 69, connected to the tanks 4 such, that pressurized gas can be introduced between the outer container 17 and the inner container 16. Preferably, the reducing valves maintain the pressure on the inner container at a desired excess pressure, so that each time a desired tapping pressure is obtained. For the kegs 5, a gas supply device 70 is provided, for instance a known CO2 bottle 71 with reducing means 72. With these, the beverage in the kegs 5 can be pressurized.

In the position shown in FIG. 1, the first connecting head 7A is brought into a first position, with the aid of the regulator device 52, while the inner space of the keg 5 is connected to the intermediate line 10A. The other connecting head 7B has been brought, by the regulator device 52, into the second position such that the intermediate line 10A is connected to the respective tapping line 9. Beverage can thus be brought from the keg 5 via the intermediate line 10A and the tapping line 9 to the sub-tapping lines 9A-D and thence be dispensed via one or more draw-off taps 3. The connecting heads 6A-D are set such that therethrough neither rinsing liquid nor beverage can flow to the draw-off taps 3 and/or in the opposite direction. To that end the first 6A of these four tapping heads can for instance be brought into the tapping position, while no pressure is applied to the respective inner container. The shutoffs 13 can also be brought into the closed position, in particular when they are designed to be remote-controlled. When the first keg 5 is empty or there is no need to otherwise tap therefrom, with the aid of the regulator device 52, the first connecting head 7A can be brought into a third position, in which the rinsing line 8 is shut off, as is the keg 5. The second connecting head 7B is brought into the first position, so that beverage can be dispensed from the second keg 5 to the draw-off taps 4. When this keg is empty, or there is no need to otherwise tap therefrom, this second shutoff is brought into the third position, so that no further beverage can flow from the keg 5, while the third connecting head 6A is brought into the first position. Then, beverage can be brought from the first holder 4 into the tapping line 9, via the intermediate lines 10B-D. Eventually, when the first holder 4 is empty or needs to be closed, the respective connecting head 6A is brought into the second position and the fourth connecting head 6B is brought into the first position, so that beverage can be dispensed from the holder 4 connected thereto, and thus further to the third tank and the fourth tank, until, for instance, all thanks and/or kegs are emptied.

The order of use of the kegs and holders, for that matter, can also be selected differently. The connecting heads 6, 7 can be connected in any desired order.

In the regulator unit 52, data are kept up to date about the beverage included in the kegs and/or holders 4, such as type, filling, date of filling or best-before date and the like. In the regulator unit, a program is included with an algorithm which determines on the basis of these data and/or instructions of, for instance, the brewer or managers, when for instance the line system is to be cleaned. This can be indicated on, for instance, the interface, such as the touch screen 79. By pushing a suitable (virtual) button on the touch screen 79, a manager can then start a cleaning cycle. The regulator unit will then bring all tapping heads 6,7 into the first second position, such that the rinsing line 8, the intermediate lines 10A-D and the tapping line 9 are in fluid communication with tapping sub-lines 9A-9D. Then, first, during a first period of time, water will be supplied from the water connection 15, with which the remaining beverage can be displaced from the intermediate lines 10A-D and/or (sub)tapping lines 9, 9A-D, by opening the draw-off taps 3. When all beverage has been displaced, during a second period of time, water with a desired amount of cleaning agent will be fed in a dosed manner, with the dosing pump 62, through the line system 2, measured and/or checked by the measuring device 74.

In the rinsing line 8, preferably, a flow sensor 73 is included, with which the flow in the rinsing line 8 and hence in the entire line system 2 can be accurately checked. It is preferred that in the regulator unit 52, an initiation program is included, in which a manager can input, preferably in an interactive manner, the layout of the tapping device 1, for instance data about the total content of the line system and the number of draw-off taps. On the basis of the data inputted by the manager, the processor determines a minimum and maximum flow value. During cleaning of the line system, the draw-off taps 3 should all be open, in order to ensure that all tapping lines, in particular sub-tapping lines 9A-D and draw-off taps 3, are cleaned according to a preselected protocol. By measuring with the flow sensor whether the flow in the rinsing line 8 is within the boundaries mentioned, it is ensured that the protocol is followed. If the flow falls below the minimum flow value (MFV), the interface 54 produces an alarm signal, for instance audible or visual. Then, the manager knows that the cleaning cycle has not proceeded properly and can take appropriate measures, for instance by restarting a cleaning cycle, after all draw-off taps 3 have been opened. Furthermore, a log of all cleaning cycles can be kept, so that at a later stage, it can be checked whether the cleaning operations have indeed been carried out properly. The system can also perform one or more of the steps mentioned automatically, for instance repeating the rinsing phase and/or terminating the beverage dispensing.

As the sensor 73 is included in the rinsing line, this does not contact the beverage, so that contamination thereof is considerably reduced. In this embodiment, the sensor 73 does not come into contact with the rinsing liquid either, because the sensor 74 is provided upstream of the non-return valve 61A. Furthermore, only one sensor is required for the entire line system. However, a flow sensor could also be included, for the same purpose, in another part of the line system 2, for instance in the tapping line 9, or in each of the sub-tapping lines 9A-D or one in each draw-off tap 3. With it, furthermore, it could be established per draw-off tap how much beverage is dispensed, so that an even more accurate management is possible.

After cleaning agent has been fed through the line system 2 for a desired period of time, clean water is once more supplied, during a third period of time, from the water connection 15. As the capacity of the line system 2 is known, which capacity can be inputted into the system in advance, and the flow of the water is measured, the regulator unit can automatically establish whether all cleaning liquid has been displaced from the line system. Only then can the cleaning cycle be terminated and the connecting head 6, 7 be brought in the desired position again for tapping beverage. With the measuring device 74, it can be determined whether all cleaning agent has disappeared from the line system. It will be clear that with this, with minimum loss of beverage and great certainty, a cleaning cycle can be carried out safely, without a manager needing to uncouple any holder or keg or needing to perform other operations to kegs and/or holders. The interface, in particular the touch screen 79 can be arranged adjacent one of the draw-off taps 3 on for instance a bar, while the kegs 5 and/or holders 4 can be arranged in, for instance, a cellar space. Then, operation of the installation can take place from the bar.

Preferably, the regulator unit is provided with communication means, preferably wireless communication means and telemetry means 80A. In each holder 4, a residual volume indicator, such as a degree of filling sensor 131 may be included, temperature sensors for the beverage and the cooling means 50 can be provided, connected to the regulator unit 52, and a sensor may be provided in the storage tank 63, also connected to the regulator unit 52. The regulator unit 54 can further be connected to an intranet, extranet or internet or similar network. With it, the regulator unit 54 can communicate with, for instance, a computer or website of the manager, so that the manager can always be kept informed of the condition of his installation 1, preferably real time, the regulator unit can communicate with a logistic system of a brewer, beverage supplier or other supplier, so that each time, orders can be given simply and online, or the possibility can even be offered to give a supplier a signal, automatically generated by the regulator unit, if the stock of a particular product, such as beer, falls below a desired minimum level inputted into the regulator unit, so that this supplier can make a delivery suggestion or can plan a delivery. It is preferred that in the regulator unit also, an option is provided with which the manager and third parties may communicate, via, for instance, e-mail, training modules for staff for, for instance, maintenance of the installation, new products, actions of consumers and the like can be represented, a brewer or manager or third parties may pass on offers, and online billing can be enabled. On the basis of data collected in the regulator unit 52, a supplier may determine what has been the turnover over a particular preceding period and send a bill or charge an account. Also, a discount can be given with a particular minimum turnover, incentives can be offered via the regulator unit and other promotional and managerial activities can be deployed.

With an installation according to the invention, management can be fully automated and be regulated and carried out from a location adjacent a draw-off tap or at least remotely from the kegs and holders. The installation 1 is preferably of modular design, with the regulator unit preferably built up with the aid of bus technology, so that modules can be added as desired, depending on, for instance, the number of kegs and/or holders and/or other containers, the connecting heads used, cooling means, cleaning means and interfaces. Such technology is sufficiently known per se to the skilled person.

Different installations or at least regulator devices and/or tapping systems can be mutually coupled and can be coupled to, for instance, a central or decentralized server, such as a management server that is managed by for instance a brewer or distributor, a franchisor or other manager. With it, information can be collected and exchanged. The coupling can be formed via, for instance, an Internet connection or an Intranet connection.

In a regulator unit or at least in a tapping device according to the invention, a control system 100 is provided, having a number of terminal buses 101 in which sensors can be connected, such as the or each flow sensor, temperature sensors, the sensor in the storage tank, but also, sensors that may be provided in a space where the draw-off taps are installed or spaces communicating therewith, such as motion sensors, cameras, temperature sensors and the like. The control system is further preferably at least partly of modular design, so that depending on, for instance, the number of containers included in a tapping systems and/or the number of draw-off taps provided therein, a number of modules can be selected. Within the control system, use can be made of PLCs for controlling different parts. Furthermore, terminal buses can be provided for, for instance, data input from the compressor(s), sensors with which the degree of filling of the holders can be measured, fire alarms and CO2 and/or other gas detectors, for protection of residing spaces, and other sensors, detectors and information sources. Twelve buses may be provided to which several of the sensors, detectors and information sources mentioned can be connected. Naturally, also another number of buses can be provided. Preferably, use is made of buses that can take and/or produce between 0 and 24 Volt. Further, for instance USB connections 102 can be provided to which for instance blue tooth applications can be connected, for instance for communication with mobile phones, computers and other electronic instruments.

With a control system 100, a touch screen 79 or other interactive control means can be provided, with which information about the condition of the system can be read and with which data and settings can be inputted into the system. In FIG. 2, schematically, a block diagram is shown of a portion of a control system 100, by way of example. Variations thereon are possible, for instance by adding or adjusting the modules 103. Preferably, each step or mode is associated with one or more “screens”, visual representation of steps, modi, options and the like. In FIG. 2, for instance screen 79 is represented in a basic screen with numerical keyboard for entering a PIN code for access to the system or parts thereof. Preferably, a setting mode 104 can be selected, in which data about the system and/or users can be inputted. The total volume of the line system and/or parts thereof may be inputted, so that it can be determined in an even simpler manner how much liquid there is in the system at which moment in time, and which liquid is involves, in particular through the use of the flow sensor and/or the measuring device 74. In the setting mode, also, data may be inputted about the types of beverage included in the holders 4, 5, best before dates of the beverage, the number of draw-off taps used and other system related data.

After the desired data have been inputted, the setting mode 104 can be abandoned and a starting up mode 105 may be commenced, in which the different connecting heads are automatically or manually brought into a desired position, so that tapping from at least one of the holders 4, 5 is enabled. A holder may be selected from which, initially, tapping should take place, for instance because the beverage therein is closest to the best-before date, which can be indicated on the screen, after which the control system automatically brings the remaining connecting heads in the suitable position.

It is advantageous when the regulator system, when switching between holders, fills up an intermediate line part 10 with water while displacing beverage included in the respective part. Thus, beverage can be prevented from remaining behind in these lines.

Also, a learning module 106 can be started, with which users of the system can be given information about, for instance, the system, such as information with respect to maintenance, status, tapping operations, settings and the like, about beverages that can be tapped, about the establishment the draw-off taps are provided in, but also, training programs for interactively teaching users the use of the system. For different types of users, different learning modules may be provided, in the form of software and/or hardware connected to the system, both real and virtual.

Further, one can proceed to a mode of use 107, in which beverage can be tapped with the aid of one or more draw-off taps, which can be operated both manually and electronically, for instance through the touch screen.

Further, one can proceed to an information mode 108. In this mode, a user can for instance read information from the touch screen, such as information about the condition of the system, messages when maintenance has to be carried out to parts of the system, such as pumps, filters, cooling means, compressors or the like, about the tapping amounts and stock, about output per draw-off tap or the system as a whole, the different sensors, detectors and other information sources. It can also be indicated on the screen when a last cleaning cycle was carried out and/or when a cleaning cycle is to be started and how the cycle runs or has run. Further, in this mode 108, information can be exchanged with users, such as consumers. Via a network such as, for instance, Internet, Intranet or via blue tooth or WiFi or such wireless systems, information can be presented about the occupation of a respective hotel, restaurant or café, number of visitors, turnover in general or of specific products in particular, or for instance offers can be made to consumers. Optionally, audio and/or visual signals can be transmitted. Consumers can be offered a service with which for instance special target groups are given special information, offers are made and the like. Thus, direct marketing can be take place, consumer research can be carried out and specific branding can be directed towards such consumer groups.

For managers of a tapping system, specific management information can be presented in the information mode 108, such as, for instance, the performance of the manager in relation to other managers connected to the system, in particular the server. A central manager, such as brewer or distributor, or for instance a marketeer can give advice via the system about improvements to the performance. Also, games may be offered via the system, between, for instance, different bars the tapping systems are installed in. Also, a search screen can be offered with which for instance information can be retrieved from a database. In such a database an overview of all hotels, restaurants and cafes offering a particular type of service or product or a combination of products and/or services may be inputted. Optionally, restrictions can be built in, for instance to postal code, area of distribution, city or region, so that the information is limited to such an area. The same or comparable information can, for that matter, also be represented visually and/or audibly in the space where the draw-off taps are installed or elsewhere in the respective place such as a pub, bar or restaurant.

It will be clear that different moth can operate or at least function side by side, as long as they do not exclude each other.

If a cleaning cycle is to be started, this is preferably indicated visually and/or audibly by the regulator system, for instance via the touch screen. Furthermore, the system will then preferably switch to a cleaning mode 109. The cleaning cycle can be started automatically but it its preferred that the manager is offered a button, for instance virtually on the touch screen, with which the cleaning cycle is started. Preferably, then, a menu of steps to be gone through is presented. This may comprise one or more of the following steps:

1—start displacing residual volume of beverage;

2—open all draw-off taps;

3—start rinsing with water;

4—start rinsing with cleaning liquid;

5—start resting phase;

6—start rinsing with water for displacing cleaning liquid;

7—close all draw-off taps;

8—start mode of use.

When starting the cleaning mode, the regulator device preferably brings the different connecting heads into the rinsing position, so that supply of beverage from the holders 4, 5 is prevented, while water and/or cleaning liquid cannot flow into the holders.

Opening all draw-off taps can be preceded by a phase in which the residual volume of beverage is dispensed. To this end, preferably per draw-off tap, the amount of beverage that is still dispensed therewith can be determined so that on the basis of the tapped volume and the known total volume of the system, in particular of the line system and at least the tapping and sub-tapping lines, the amount of residual volume still present in the lines can be determined, so that it can be determined when each of the tapping and sub-tapping lines 9, 9A still contains water. Then, it can be indicated per draw-off tap whether a residual volume of beverage can still be dispensed therewith. When all these lines have been “put on water”, all draw-off taps can be opened and kept open, and the actual cleaning can commence.

Each of the phases 1-8 can be started manually, for instance by operating a (virtual) button, preferably adjacent a draw-off tap, which for instance appears or becomes active after a preceding phase has been rounded off, yet different steps can also be taken automatically. For instance, the duration of the phases 3, 4 and 6 can be controlled on the basis of the volume of the line system and the measured flow in the line system, measured by the sensor 73. Each of these phases can for instance be terminated if a specific flow rate has been fed through the line system or after a particular duration of time. Here, especially for these phases and in particular for phase 6, it is of importance that all draw-off taps remain open between phase 2 and phase 7, so that all parts of the line system are cleaned and rinsed, so that no cleaning liquid remains behind. To that end, a minimum flow threshold (MFT) can be set in the regulator system. With the flow sensors 73 it can each time be measured whether there is a flow above the MFT and/or it can be checked whether a minimum volume of clean water is fed through the line system, which minimum volume is determined by the total volume of the line system, preferably at least once this volume. Further, with a sensor, for instance a conductivity meter 74 or a pH meter, it can be checked whether clean water or cleaning liquid is fed through. If the flow falls below the MFT, insufficient liquid flows through which is an indication that somewhere in the line system an obstruction has occurred and/or a draw-off tap is closed off. Then, the regulator system will give off a warning and/or the cleaning cycle will be interrupted and/or terminated. A new cycle can be started after the obstruction has been eliminated and all draw-off taps are open again. Naturally, it can also be detected in another manner whether all draw-off taps are open, for instance with a sensor on each draw-off tap.

Furthermore, a management mode 110 can be selected, with which for instance stock control can be controlled. For instance, beverage can be automatically ordered if the stock falls below a predetermined minimum, information about the stock can be exchanged with a manager, brewer or supplier, automatic payment can be effected for consumed beverage or other products, parts can be ordered, checked and inventory of stock can be kept. Preferably, a manager of a pub with a tapping device may log in via a connection in a databank of his system or on a central network in order to check and/or process the respective data. Via a regulator system and/or network according to the invention, central stock control can be effected, supply routes for different outlets can be automatically determined with a respective system and optionally other outlets and the like. Also in this manner, maintenance and inspection of the tapping device can be controlled.

Preferably, a regulator device is operated by software, for instance a software product that is computer readable and may be downloaded or uploaded from and to the regulator system, or be provided centrally, while the different regulator systems can serve as terminal servers or combinations thereof.

Preferably, with the aid of the regulator system, different user and management levels can be set which can be separately secured by entering a code or key, for instance a PIN-code with the aid of the touch screen. Access for users such as bar staff for tapping or requesting or giving general information, access for a manager for carrying out management operations and access for installers and the like for settings, maintenance and the like.

Preferably, the flow in the line system is measured for checking whether this does not fall below the MFT, which would indicate an obstruction or a closed draw-off tap, and a flow through volume is measured or calculated from the flow, in order to ensure that sufficient rinsing liquid and, in particular, sufficient clean water has been fed through after rinsing liquid has been introduced into the lines and has, for instance, stood therein for some time.

Conductivity measurement or another measurement can be used for determining the composition of the liquid in the line system, as additional check to the removal of all cleaning agent before tapping is resumed.

Optionally, a coloring or another marker can be added to the cleaning agent, while a detector for the color or other marker can be provided, instead of or in addition to the conductivity sensor, with which it can also be checked whether the line system contains clean water. The fact is that if the color or marker mentioned is no longer detected after rinsing with clean water, all cleaning is agent is removed and tapping can be resumed.

The invention is not limited in any manner to the embodiments represented in the description and the drawings. Many variations thereon are possible. For instance, parts of a tapping device and/or regulator device can be designed differently and be combined, wherein parts can be omitted or several loops may be provided in the line system. The regulator system can comprise all modules and modes mentioned but also just a few. Preferably, in any case, the cleaning cycle is operable and controllable by the regulator system.

1. A control system for a beverage dispensing apparatus, wherein the beverage dispensing apparatus comprises at least one line system with at least one rinsing line and one tapping line and at least one holder for beverage, wherein the control system comprises a flow sensor, wherein the control system comprises operating means for switching between a first condition in which beverage can be dispensed from the holder via the tapping line and the rinsing line is separated from the tapping line and a second condition in which rinsing liquid and/or water can be introduced via the rinsing line into the tapping line and the holder is separated from the tapping line and the rinsing line.

2. A control system according to claim 1, wherein the control system comprises a comparator for comparing, in the second condition, flow in the rinsing line, preferably measured with said flow sensor, with a set minimum flow threshold value (MFT), and means for generating an alarm signal when said flow falls below said minimum flow threshold value (MFT).

3. A control system according to claim 2, wherein the means for generating an alarm signal comprise a display on which said alarm signal is represented as an image.

4. A control system according to claim 1, wherein means are provided for operating a shutoff in the rinsing line.

5. A control system according to claim 1, wherein means are provided for operating a three-way valve between a first position wherein the rinsing line is brought into fluid communication with the tapping line, and a second position wherein said holder is brought into fluid communication with the tapping line.

6. A control system according to claim 1, wherein means are provided for operating a shutoff for supply of rinsing agent to the rinsing line.

7. A control system according to claim 1, wherein at least one sensor is provided for measuring the degree of filling of said at least one holder.

8. A control system according to claim 1, wherein timer means are provided for timing the duration of the second condition.

9. A control system according to claim 1, wherein an operating panel is provided for operating the said operating means, which operating panel preferably comprises a touch screen.

10. A control system according to claim 1, wherein communication means are provided for communication via a computer network and/or a wireless network between said control system and external electronic means.

11. A control system according to claim 1, wherein a data collecting unit is provided for collecting data of sensors connected to the control system, wherein means are provided for uploading and downloading information to and from said database.

12. A regulator unit for use in a control system according to claim 1, comprising at least one processor and a series of buses.

13. A method for managing a beverage dispensing apparatus, preferably according to claim 1, wherein in a central operating system information is collected and stored about at least one of: connected holders, amounts of beverage present in the holders, best-before dates with respect to said beverage in said holders and cleaning data of the beverage dispensing apparatus, wherein in the operating system an algorithm is included for determining on the basis of said information a cleaning interval or cleaning moment and/or for running a cleaning program, which program, upon activation by a user:
seals off the or each holder from the or each tapping line of the beverage dispensing apparatus;
connects a rinsing line of the beverage dispensing apparatus to the or each tapping line;
during a first period, displaces beverage from the or each tapping line by introducing water and/or rinsing liquid via the rinsing line into the or each tapping line, while displacing the beverage present therein;
during a first period, feeds rinsing liquid through the rinsing line and tapping line or tapping lines;
during a second period, feeds water through said rinsing line and tapping line or tapping lines, for displacing rinsing liquid from at least the tapping line or tapping lines;
after a second period, connects at least one holder to the tapping line or tapping lines, while disconnecting the fluid communication between the said rinsing line or the or each tapping line.

14. A method according to claim 13, wherein during at least the first and/or second period, flow of rinsing liquid and/or water through the rinsing line is measured and is compared to a minimum flow threshold value included in the control system, wherein an alarm signal is produced when the measured flow falls below said minimum flow threshold value.

15. A method according to claim 13, wherein by the control system, information is exchanged with a manager of the control system and/or of the beverage dispensing apparatus, a maintenance service for the beverage dispensing apparatus, a logistic body for supply of beverage and/or a commercial department of a producer and/or supplier of the beverage.

16. A method according to claim 13, wherein in the control system, data with respect to the beverage dispensing apparatus are inputted, among which at least the volume and/or the length of the rinsing line and the or each tapping line and the number of draw-off taps connected to the line system, wherein the control system on the basis of these data determines a minimum flow threshold value for said line system during a cleaning phase.

17. A computer software product for a control system according to claim 1.

18. A control system for a beverage dispensing apparatus, preferably according to claim 1, wherein a regulator system is included that comprises at least one module from the series of:
a mailbox system module;
a module for registration of beverage dispensing history;
logistic information module for a manager of the beverage dispensing apparatus, preferably with an indication means for accepting or refusing a logistic data such as for instance date of delivery or ordering information;
communication module, in particular wireless and preferably Blue Tooth, for communication by the manager with clients, consumers, suppliers and the like.

19. A computer software product for carrying out a method according to claim 13.
